(19) United States
(12) Patent Application Publication
(10) Pub. No.: US 2010/0107419 A1
(43) Pub. Date: May 6, 2010

(54) Eating utensil incorporating oral cleaning facility

(76) Inventor: Jackson L. Crisp, Bakersfield, CA (US)

Correspondence Address: J.E. McTaggart;U.S. Patent Agent, 6650 Crescent Street, Suite 4, VENTURA, CA, 93003, US

(21) Appl. No.: 12/592,653

(22) Filed: Dec. 1, 2009

Related U.S. Application Data
(62) Division of application No. 12/231,274, filed on Sep. 2, 2008.
(60) Provisional application No. 61/133,106, filed on Jun. 25, 2008.

(51) Int. Cl. A47J 43/28; A61C 15/00; B26B 3/00; A47L 25/00

(52) U.S. Cl. 30/147; 30/150; 30/324; 132/324; 30/165; 15/111

(57) ABSTRACT

An eating utensil such as a disposable plastic fork, spoon, knife, or combination thereof, is combined with at least one oral cleaning device such as a toothpick, interdental pick, brush, tongue cleaner and/or a dental flosser for personal use after eating in a location where oral cleaning facilities may not be otherwise available. In some embodiments the oral cleaning device may be permanently attached to the eating utensil, which can serve as a handle for using the oral cleaning device. In other embodiments the oral cleaning device may be displaced in a snap-off or bend-away manner at score lines to expose the oral cleaning device for use, either still attached to the utensil or removed for separate use, optionally configured with a thumb-finger grip tab.

### PRIORITY

The present application is a division of application Ser. No. 12/231,274, filed Sep. 2, 2008, claiming priority from provisional application 61/133,106, filed Jun. 25, 2008.

### FIELD OF THE INVENTION

The present invention is in the fields of eating utensils and oral cleaning devices, more particularly the invention relates to an eating utensil that incorporates at least one oral cleaning device from a group that includes toothpicks, tongue-cleaners and oral brushes. Optionally one or more additional oral cleaning devices may be incorporated.

### BACKGROUND OF THE INVENTION

Eating activity often involves the use of disposable eating utensils, such as plastic forks, spoons and/or knives, typically at away-from-home locations where facilities for oral cleaning after eating are unavailable.

Such eating activity may include planned picnics, picnics-on-the-go, fast food, takeout, lunch boxes, bagged lunches at work, eating-on-the-go, delivered specialties, catered food engagements, entertainment events, birthdays, cocktail-parties, weddings and other parties.

### DISCUSSION OF KNOWN ART

U.S. design patent D254,239 to Julius shows the ornamental design for a COMBINED FORK AND SEPARATABLE TOOTHPICK.

U.S. design patent D463,221 to Sanders for EATING UTENSIL WITH TOOTHPICK INCORPORATED THEREIN shows a fork, spoon and knife each with a presumably removable toothpick located on the front side near the handle end.

U.S. Pat. No. 2,877,547 for COMBINATION TOOTHPICK AND STIRRING OR EATING IMPLEMENT to Feaster discloses wooden spoons, forks and stirring sticks configured with knockout-removable toothpicks.

U.S. Pat. No. 2,072,777 to Takahashi for CUTLERY shows a spoon and a fork each with a pair of toothpicks removably attached on the rear side.

U.S. Pat. No. 3,664,020 to Hammond et al for COMBINATION SPOON AND TOOTHPICK shows and discloses a toothpick and spoon combination including a handle portion with a separable toothpick member for use after eating. The combination utilizes support members from which the toothpick may be broken away.

### OBJECTS OF THE INVENTION

It is a primary object of the present invention to provide disposable plastic utensil embodiments incorporating an oral cleaning device such as a straight or curved toothpick, tongue cleaner and/or oral brush, along with one or more optional additional devices, e.g. a dental flosser, for maintaining good oral hygiene and health at eating events where oral cleaning devices may not be otherwise available.

It is a further object to provide snap-off embodiments wherein an oral cleaning device, initially formed attached in a protective manner in an opening in the utensil handle, can be user-displaced in a snap-off manner and removed for separate usage, and further, to provide bend-away embodiments wherein a device, permanently attached in protective manner within the utensil handle, can be user-displaced in a bend-away manner that exposes the still-attached device, ready for use.

### SUMMARY OF THE INVENTION

The foregoing objects have been met in the present invention wherein a plastic eating utensil is combined with an oral cleaning device that can be molded integrally with the utensil handle, initially attached to the handle and typically protected by adjacent or surrounding handle material. To deploy a protected device, one or more score lines configured in the handle enable user-displacement of the device and/or a selected area of handle material in a manner to expose the device ready for usage. User-displacement can be implemented in different embodiments as either non-separation bend-away or snap-off separation, depending on design choice of plastic material for resilience, and of score line configuration, particularly depth.

### BRIEF DESCRIPTION OF THE DRAWINGS

The above and further objects, features and advantages of the present invention will be more fully understood from the following description taken with the accompanying drawings.

FIG. 1 shows a fork with a curved toothpick attached at the end region alongside an adjacent guard tab that is attached to the handle in a manner to be displaceable at a score line.

FIG. 2 shows a user's hands in process of displacing the toothpick of FIG. 1 for exposure and use.

FIG. 3 shows a fork with a curved toothpick extending from an end region that is score-line-attached to the handle.

FIG. 4 shows a fork with an edge-located tapered toothpick attached to an end tab that is score-line-attached to the handle.

FIG. 5 shows a fork with an attached centered tapered toothpick guarded by an end tab that is displaceably attached to the handle by a pair of score lines.

FIG. 6 shows a fork with a centered curved toothpick attached to an end tab that is displaceably attached to the handle by a pair of score lines.

FIG. 7 shows a fork with an end-located curved toothpick attached by a score line.

FIG. 8 shows a fork with an edge-located score-line-attached straight toothpick.

FIG. 9 shows a fork with a centered score-line-attached straight toothpick.

FIG. 10 shows a fork with an attached curved toothpick extending longitudinally from the end of the handle, ready-to-use.

FIG. 11 depicts a fork with an attached curved toothpick extending laterally from the end of the handle, ready-to-use.

FIG. 12 depicts a fork configured with an attached ready-to-use flosser and a guarded centrally-located removably-attached straight toothpick.

FIG. 13 depicts a fork configured with a user-displaceable combination flosser and edge-located tapered toothpick

FIG. 14 depicts a fork configured with a user-displaceable combination flosser and centrally-located tapered toothpick.

FIG. 15 depicts a cutlery knife combined with a removable grip-tab toothpick.

FIG. 16 depicts a spoon combined with a displaceable interdental pick configured with a grip-tab that initially constitutes the end region of the handle.

FIG. 17 depicts a spork (spoon/fork) combined with a displaceable grip-tab oral brush.

FIG. 18 is a front cut-away view of a utensil handle showing a tongue cleaner integrally formed in the end region of the handle.

FIG. 19 is a cut-away side view of the utensil handle of FIG. 18 showing the tongue cleaner of

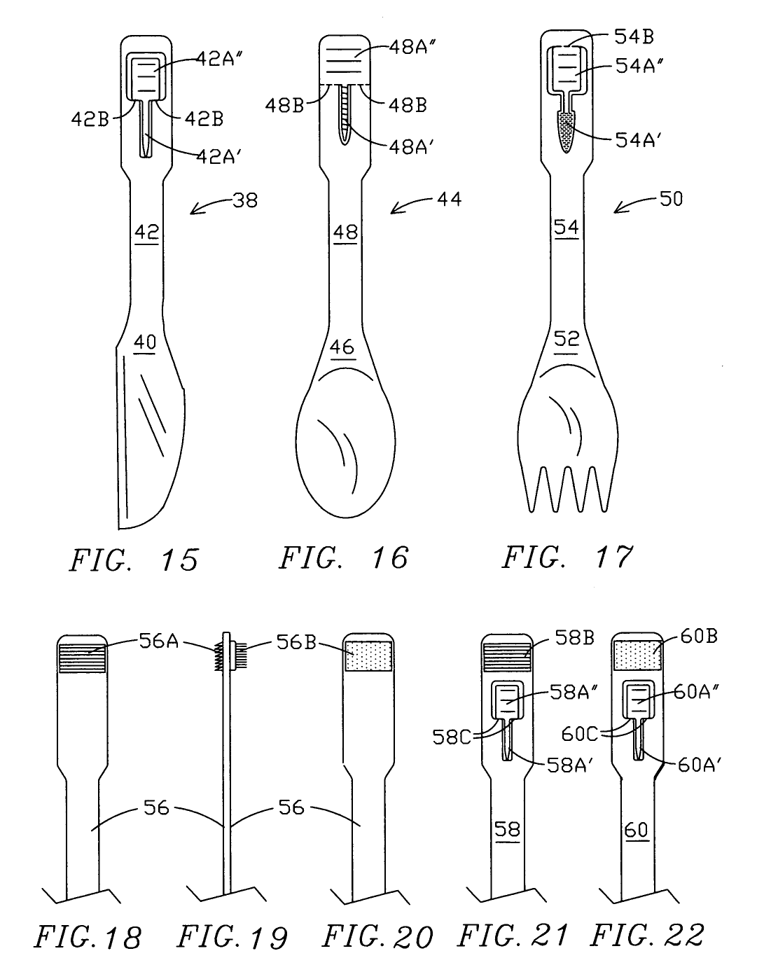

FIG. 18 on one side and a bristle brush located on the opposite side.

FIG. 20 is a rear view of the utensil handle of FIG. 18 showing the bristle brush of FIG. 19 in the end region.

FIG. 21 is a cut-away front view of a utensil handle configured with a straight grip-tab toothpick and a tongue cleaner in the end region.

FIG. 22 is a rear view of the utensil handle of FIG. 21 equipped with straight grip-tab toothpick and an oral brush in the end region.

### DETAILED DESCRIPTION

FIG. 1 depicts a fork 10 configured with an attached curved toothpick 10A, protected on one side by an adjacent guard tab 10B that is made user-displaceable at score line 10C so as to expose toothpick 10A for use. Depending on design selection of handle material and configuration of score line 10C, (a) in a bend-away embodiment, tab 10B can be bent back and held by a user to expose the toothpick for usage, but remains attached as a guard for future usage of the fork 10, whereas (b) in a snap-off embodiment, snap-off removal of guard tab 10B leaves toothpick 10A permanently exposed and unguarded.

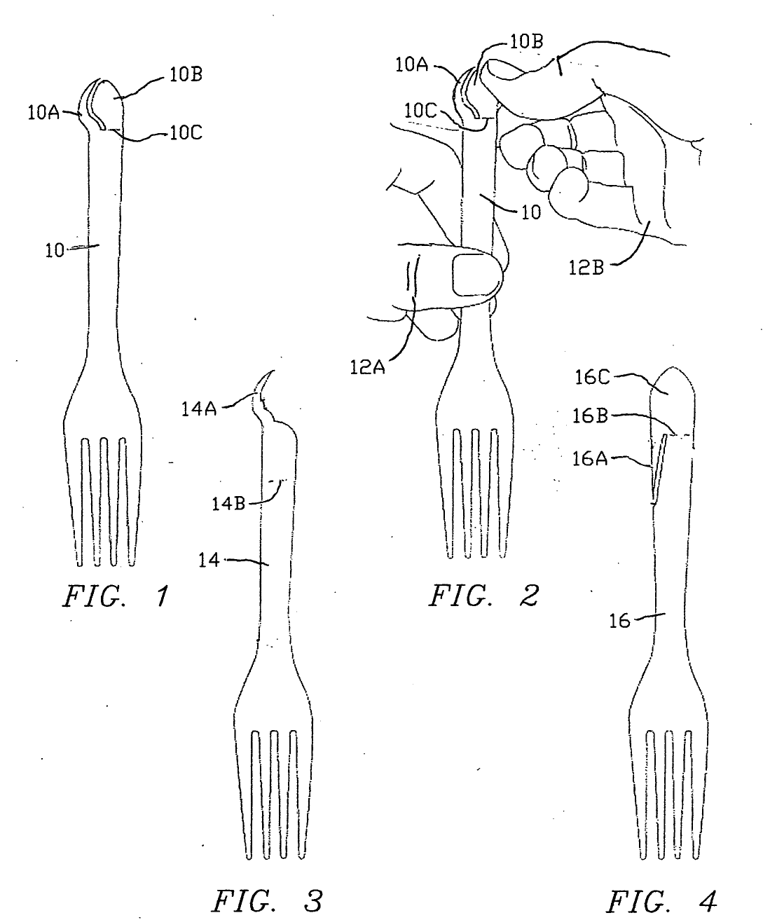

FIG. 2 shows a user's left hand 12A holding a fork 10 of FIG. 1 while the right hand 12B is shown in process of displacing the guard tab 10B at score line 10C, to expose toothpick 10A ready to use, remaining attached to fork 10 which serves as a handle.

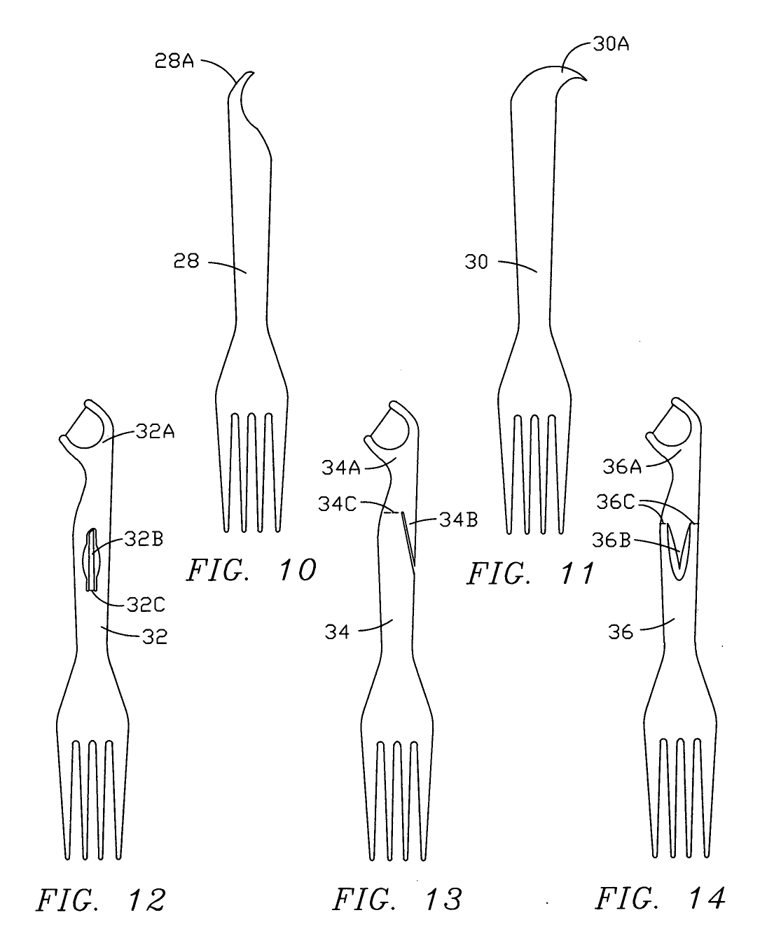

FIG. 3 depicts a fork 14 configured with a snap-off curved toothpick 14A, extending longitudinally from the handle. In a primary version, toothpick 14A is made readily removable by snapping off at score line 14B, providing the toothpick separately with a thumb-finger grip. In a secondary version, score line 14B is made relatively stiff so that toothpick 14A can be considered ready-to-use while remaining attached to fork 14 which serves as a handle. In still another version (FIG. 10), score line 14B is omitted.

FIG. 4 depicts a fork 16 configured with a tapered toothpick 16A that is edge-located and attached to a user-displaceable end tab 16C. A score line 16B, from the base end of toothpick 16A to the handle edge, enables a user to displace tab 16C and thus expose toothpick 16A for use; in a bend-away embodiment, toothpick 16A would remain attached to the handle along with bent back tab 16C, whereas in a snap-off embodiment, toothpick 16A would be removed from the handle along with end tab 16C, which would serve as a thumb/finger grip tab to facilitate use of the toothpick 16A.

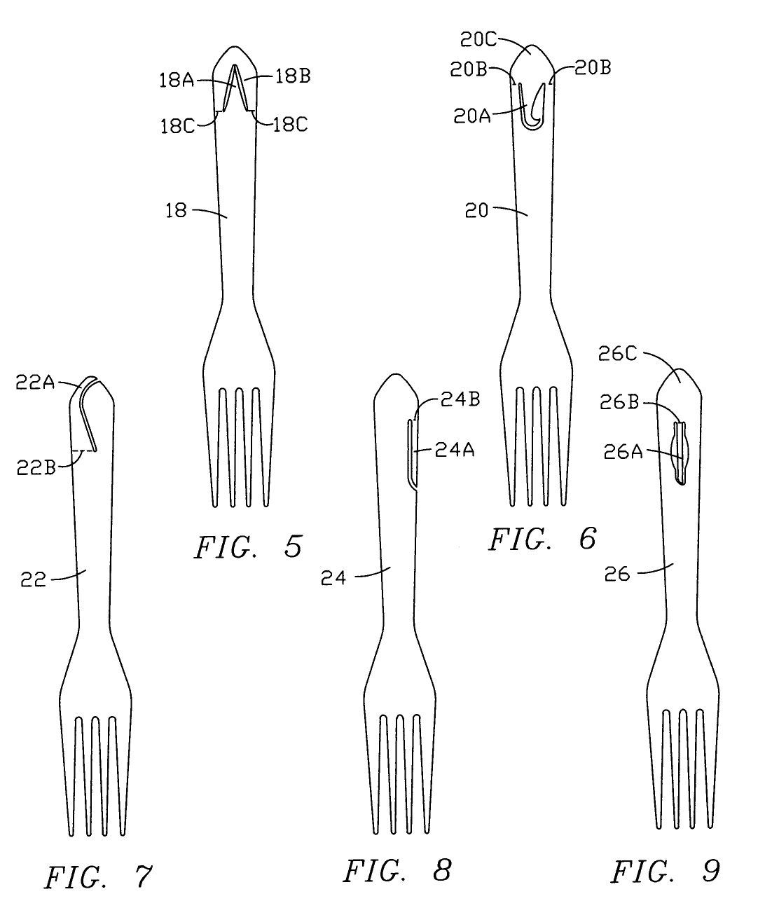

FIG. 5 depicts a fork 18 configured with an attached toothpick 18A that is fully protected by a user-displaceable end tab 18B, which, when user-displaced at score lines 18C, exposes toothpick 18A for use. In a bend-away embodiment, end tab 18B remains attached to the handle of fork 18, facilitating subsequent further use of the fork, whereas in a snap-off embodiment, end tab 18B is snapped off (and typically discarded) to expose the toothpick 18A ready to use, attached to the fork 18 which serves as a hand grip.

FIG. 6 depicts a fork 20 configured with a fully guarded curved toothpick 20A which, in a snap-off embodiment, when snapped off by user displacement at score lines 20B, includes a thumb-finger grip tab 20C. In a bend-away embodiment, when tab 20C is bent back by user displacement at score lines 20B, toothpick 20A becomes exposed, ready for use.

FIG. 7 depicts a fork 22 configured with a partially-guarded curved toothpick 22A which, in a snap-off embodiment, when snapped off at score line 22B, includes a triangular portion that can serve as a thumb-finger grip tab.

FIG. 8 depicts a fork 24 configured with a partially-guarded straight toothpick 24A which, in a snap-off embodiment, snaps off at score line 24B for use as a separate item.

FIG. 9 depicts a fork 26 with a fully guarded straight toothpick 26A which, in a snap-off embodiment, snaps off at score line 26B for use as a separate item, leaving the handle end 26C in place with its original outline shape intact.

FIG. 10 depicts a fork 28 with an unguarded attached curved toothpick 28A, oriented longitudinally, ready to use.

FIG. 11 depicts a fork 30 with an unguarded attached curved toothpick 30A, oriented laterally, ready to use.

FIG. 12 depicts a fork 32 in combination with an attached flosser 32A, ready to use, and an initially attached straight toothpick 32B that snaps off at score line 32C for removal and separate usage. The floss in flosser 32A can be secured in place at the ends of the flosser opening by molding into the plastic material at manufacture or by forcing the floss into narrow V-shaped grooves.

FIG. 13 depicts a fork 34 configured with an edge-located semi-guarded tapered toothpick 34B and a flosser 34A with a score line 34 located to enable a user to expose toothpick 34B for use by dislocating toothpick 34B and a flosser 34A as a combo. Score line 34C is made sufficiently stiff to enable immediate use of flosser 34A with the combo attached in line with the fork 34 as shown, the fork serving as a handle. In a snap-off embodiment, the combined toothpick 34B and flosser 32 can be snapped off from fork 34 at score line 34C, providing the combo of both dental cleaning devices ready to use as a separate unit. In a bend-away embodiment, the user can expose the toothpick 34B for use at any time by bending back the combo at score line 34C.

FIG. 14 depicts a toothpick 36B and a flosser 36A in a combo configuration similar to that in FIG. 15 except that toothpick 36B, being centered in the handle, is initially fully guarded by surrounding handle material and is flanked by a pair of score lines 36C for user-displacement; otherwise the capabilities and method of use are as described in connection with FIG. 14.

In a configuration similar to that in FIG. 14, the toothpick and its surrounding guard region opening could be inverted (i.e. rotated 180 degrees) to appear as in FIG. 5. Then, in a snap-off embodiment, the flosser would snap off for separate use, exposing the toothpick ready for use (like 18A in FIG. 5), still attached to the fork In a bend-away embodiment, the flosser would fold back to expose toothpick for use.

FIG. 15 is a front view of an embodiment 38 of the invention wherein the utensil portion is a cutlery knife 40; its handle 42 is configured in its end region with a fully guarded toothpick 42A′ configured with an enlarged base tab 42A″ that serves as a thumb-finger grip. In a snap-off embodiment, toothpick 42A′ and its attached tab 42A″ can be snapped off at score lines 42B and removed for separate use.

FIG. 16 is a front view of an embodiment 44 of the invention wherein the utensil portion is a spoon 46; its attached handle 48 is configured with an interdental pick 48A′ having an enlarged base tab 48A″ that initially forms the end of handle 48 as shown. In a snap-off embodiment, toothpick 48A′ and attached tab 48A″ can be snapped off at a pair of score lines 48B and removed for separate use. In a bend-away embodiment, toothpick 48A′ and attached tab 48A″ can be deployed by the user bending tab 48A″ back 180 degrees at the pair of score lines 48B, thus exposing interdental pick 48A′ ready for use.

FIG. 17 is a front view of an embodiment 50 of the invention wherein the utensil portion is a spork 52, i.e. spoon/fork, with attached handle 54 configured in its end region with a fully guarded interdental brush 54A′ with an attached enlarged base tab 54A″ that serves as a thumb-finger tab. In a snap-off embodiment, brush 54A′ and attached tab 54A″ can be snapped-off at score line 54B, located along the top edge of base tab 54A″, and removed for separate use. In a bend-away embodiment, interdental brush 54A′ and its attached tab 54A″ can be bent away at score line 54B.

FIG. 18 is a cut-away front view of an eating utensil handle portion 56 including a tongue cleaner 56A located in the end region. Tongue cleaner 56A can be implemented as a row of ridges that can be molded integrally with handle portion 56. Alternatively, tongue cleaner 56A can be implemented as at least one scraping edge, intended to scrape the tongue to remove debris while not causing injury to tongue. As a further option, the region of handle portion 56 that contains the tongue cleaner 56A could be made with permanent bends or made flexible so as to make accessing the tongue easier; the tongue cleaner could be configured with at least one opening that allows debris from the scraping action to pass thru, preferably to a designated collection area.

FIG. 19 is a cut-away side view of utensil handle 56 as in FIG. 18 showing a side view of tongue cleaner 56A, also showing a side view of a bristle brush 56B in the end region on the opposite rear side. The side view of tongue cleaner 56A shows a sawtooth profile shape of the ridges, with the ridge-tips being formed with designated sharpness, appropriate to tongue cleaning. Brush 56B is typically fabricated as a separate item, with bristles of appropriate length and stiffness, and affixed to the end region of handle 56.

FIG. 20 is a cut-away rear view of the utensil handle 56 and brush 56B of FIG. 19. Optionally brush 56B could be implemented as any type of brush that can be used orally, e.g. bristle-type oral brush, interdental-type oral brush, pad/fabricated-type of brush and combinations thereof. The oral brush 56B can be directly molded into the eating utensil handle 56 and/or procured separately and affixed to the handle. The portion of the utensil handle 56 that contains the oral brush could be made with one or more permanent bends or made flexible so as to make accessing teeth/tongue easier; and bristle-type oral brushes could vary in such areas as, but not limited to, count, arrangement, stiffness, color, width, length, material, attachment method to base and combinations thereof.

FIG. 21 is a cut-away front view of an eating utensil handle 58 including a fully guarded snap-off straight toothpick 58A′ with a base tab 58A″ and a tongue cleaner 58B located near the end of handle 58 as in FIG. 18. Toothpick 58A′, along with its base tab 58A″, snaps off at a pair of score lines 58C as shown, to be removed for separate use.

FIG. 22 is a cut-away front view of the eating utensil handle 60 including a fully guarded snap-off straight toothpick 58A′ attached to base tab 58A″, as in FIG. 21, and a brush 60B located near the end of handle 60 as shown and described in connection with FIGS. 19 and 20.

In the present disclosure, unless otherwise indicated, the use of the term toothpick or showing thereof is intended to include an interdental pick or an interdental brush.

While the invention is directed primarily to an unfulfilled need and expected demand in conjunction with disposable plastic eating utensils which are likely to be popular at picnics and other social or public eating events where regular dental cleaning facilities are unavailable, the invention could be practiced in conjunction with more permanent type eating utensils intended for more general use. The material in the eating utensil can be metal or any material that can provide the desired break-away or bend-back embodiment. As an alternative to the generally one-piece construction shown for the eating utensil, it could be made from a plurality of parts joined by fastenings such as welding or adhesives.

Standard fork or spoon designs could include, but are not limited to, such features as ribbed-supports and similar structural/cosmetic elements.

To deploy a toothpick or other oral hygienic device that is initially at least partially guarded by adjacent or surrounding handle material, displacement from the initial location is required. Such displacement can be implemented as one of two basic approaches: snap-off or bend-away displacement, depending on design selection of handle material for resilience and the characteristics of special displacement-related configurations in the handle material known as score lines i.e. lines in which the basic handle strength is reduced locally e.g. by slots, V-grooves, perforations, embossing, etc., configured on one or both sides of the handle and having the effect of reduced material thickness and thus reduced strength along the score line(s). In the design of snap-off embodiments, the material is selected to be relatively brittle and the score line depth is made to enable a user to break the material at the score line. Generally the depth of the score line is chosen to make snap-off easy and convenient, however in special embodiments that require initial stiffness, the score line is made shallower, requiring greater force for snap-off separation. In the design of bend-away embodiments, a more resilient material is selected that can be bent or folded without breaking off at the score line.

Optional locations of score lines provide many potentially beneficial configurations/embodiments, e.g.:

(a) for user displacement, i.e. snap-off or bend-away, of a device by itself, the score line is simply extended across an edge, typically the base, of the device as shown in FIGS. 7-9, 15-17, 21 & 22.

(b) similarly, an end portion area that forms a protective tab can be made to be displaceable at a score line located across its base as shown in FIGS. 1 & 2;

(c) for a device with one side edge forming part of the handle side edge, a score line extending from a side edge of the device to a corresponding side edge of the handle allows the device to remain permanently attached to the utensil handle or to the end portion (depending on device orientation) when the end portion is snapped-off or bent-away from the utensil handle, thus providing an attached thumb-finger grip tab to facilitate use of the device, as shown in FIGS. 4 & 8;

(d) similarly, for a device located within the handle outline, a pair of score lines extending from side edges of the device base to corresponding opposite side edges of the handle allows the same capability as in (c), as shown in FIGS. 5, 6 & 16; and

(e) a score line can be simply extend fully across the handle at a selected location, enabling the handle to be snapped off into two pieces (or bent-away) at the score line, typically leaving an area of handle material permanently attached to the device to serve as a thumb/finger grip tab, as shown in FIG. 3.

As alternatives to the dental cleaning device being attached to the eating utensil in a permanent or break-away manner with score lines as shown, the invention could be practiced with such attachment made by other fasteners such as temporary glue, magnets, snap-fits, Velcro or the like. It could be arranged for break-away parts to be re-attached.

In embodiments where the dental cleaning device is a toothpick, extreme sharpness at the working end of the toothpick should be avoided as hazardous; instead the point should be made slightly rounded, sufficient to avoid injury, while still shaped optimally to provide effective cleaning capability.

The dental cleaning device, shown as a toothpick or flosser, could also include items such as a tooth brush, finger-brush or tongue cleaner integrated into the eating utensil by attachment means such as mold-integration, adhesive or welding, or alternatively bundled in an eating-kit package including one or more eating utensils and/or related items such as a napkin.

As an alternative to floss where a flosser is shown, a rigid, semi-rigid or flexible thin fin or blade could be provided to clean between and around the teeth.

As an alternative to the flosser with a piece of floss suspended between two prongs as shown, the floss could be provided stored in the eating utensil body, attached loose thereto or bundle-wrapped.

For embodiments such as those shown in FIGS. 3, 10 and 11 where toothpick extends unguarded, a lid or cap of some kind could be included for use as a cover or sheath.

The dental cleaning device could further provide an appropriately designed rough or raised surface, located on its surface or on that of the eating utensil, that could aid in the removal of debris located on the inner walls of the teeth. The debris removal would occur on the insertion and removal of the dental cleaning device.

As an alternative to incorporating the dental cleaning device within or directly attached to the eating utensil, one or more cleaning device and/or one or more eating utensil could be included separately side-by-side in sheet of plastic made and arranged to enable break-away removal for use.

Supplemental items such as dental floss, tissue paper or mouth wash could be provided either separately, stored within or attached to the eating utensil body in some manner, optionally bundle-wrapped and/or hygienic eating utensils could be individually wrapped.

The invention may be embodied and practiced in other specific forms without departing from the spirit and essential characteristics thereof. The present embodiments are therefore to be considered in all respects as illustrative and not restrictive, the scope of the invention being indicated by the appended claims rather than by the foregoing description; and all variations, substitutions and changes which come within the meaning and range of equivalency of the claims are therefore intended to be embraced therein.

1. A combination eating utensil and oral cleaning facility, comprising:
a utensil portion of a type selected from a group consisting of forks, spoons, knives and combinations thereof;
a handle portion extending from said eating utensil portion to an end region of the handle portion; and
an oral cleaning device of a type selected from a group consisting of a toothpick, an interdental pick, an interdental brush, a tongue cleaner and an oral brush, made in conjunction with and initially attached to said handle portion.

2. The combination eating utensil and oral cleaning facility as defined in claim 1 wherein
said handle portion is configured in a manner to enable bend-away displacement of at least one said oral cleaning device, for use without detaching from said handle portion.

3. The combination eating utensil and oral cleaning facility as defined in claim 1 wherein said oral cleaning device comprises a said toothpick

4. The combination eating utensil and oral cleaning facility as defined in claim 15 wherein said oral cleaning device comprises:
said toothpick having a side edge initially aligned with a side edge of said handle portion, said toothpick having a base end initially attached to said handle portion along a portion of a baseline traversing said handle portion; and
a score line, located along a selected portion of the baseline, made and arranged to enable a user to displace and expose said toothpick ready for use.

5. The combination eating utensil and oral cleaning facility as defined in claim 1 further comprising;
said oral cleaning device being located in the end region of said handle portion, in an opening therein surrounded by a protective region of handle material;
a base end of said oral cleaning device being permanently attached to said handle portion; and
a pair of score lines, configured in said handle portion, extending from respective opposite side edges of the base end of said oral cleaning device to corresponding side edges of said handle portion, said score lines being made and arranged to enable a user to displace the protective region and thus expose said oral cleaning device, remaining attached to said handle portion, ready for use.

6. The combination eating utensil and oral cleaning facility as defined in claim 1 further comprising;
said oral cleaning device being located in an opening in said handle portion surrounded by a protective area of handle material, said oral cleaning device having a base end oriented toward and permanently attached to the end region; and
a pair of score lines, configured in the end region, extending from respective opposite side edges of the base end of said oral cleaning device to corresponding side edges of said handle portion, said score lines being made and arranged to enable a user to displace the end region and thus expose said oral cleaning device, remaining attached to the displaced end portion, ready for use.

7. The combination eating utensil and oral cleaning facility as defined in claim 15 further comprising;
said toothpick, constituting said oral cleaning device, configured in the end region with a curved an edge of said toothpick forming a portion of an end outline of said handle portion;
a base end of said toothpick, directed toward said utensil portion;
a displaceable score line extending across the base end; and
said toothpick being thusly protected on one side by an adjacent tab of handle material permanently attached to said handle portion, such that, upon displacement at said score line, said toothpick becomes exposed, ready for use.

8. The combination eating utensil and oral cleaning facility as defined in claim 15 comprising;
said toothpick, constituting said oral cleaning device, having a side edge thereof initially aligned with a portion of a side edge of said handle portion;
said toothpick being oriented with a base end thereof directed toward the end region; and
a score line, configured across the base end of said toothpick, made and arranged to enable user-displacement of said toothpick to expose said toothpick ready for use.

9. The combination eating utensil and oral cleaning facility as defined in claim 1 further comprising;
said oral cleaning device being initially located in an opening in said handle portion, surrounded and protected by handle material;
a base end of said oral cleaning device, initially attached to said handle portion; and
a score line, configured across the base end of said oral cleaning device, made and arranged to enable user-displacement and exposure of said oral cleaning device ready for use.

10. The combination eating utensil and oral cleaning facility as defined in claim 1 wherein said oral cleaning device is integrally formed from and permanently attached to said handle portion.

11. The combination eating utensil and oral cleaning facility as defined in claim 1 wherein said oral cleaning device is integrally formed from and permanently attached to said handle portion, extending from the end region ready for use.

12. The combination eating utensil and oral cleaning facility as defined in claim 9, further comprising a dental flosser extending from the end region, ready for use.

13. The combination eating utensil and oral cleaning facility as defined in claim 4, further comprising a dental flosser extending from the end region, ready for use.

14. The combination eating utensil and oral cleaning facility as defined in claim 6, further comprising a dental flosser extending from the end region, ready for use.

15. The combination eating utensil and oral cleaning facility as defined in claim 1 wherein said toothpick is selected from a group including a straight toothpick, a tapered toothpick, a curved toothpick, an interdental pick, and an interdental brush.

16. The combination eating utensil and oral cleaning facility as defined in claim 1 wherein said oral cleaning device is initially protected by a displaceable guard region of handle material.

17. The combination eating utensil and oral cleaning facility as defined in claim 1, wherein said eating utensil is a selected as said spork.

18. The combination eating utensil and oral cleaning facility as defined in claim 1, wherein said oral cleaning device is a selected as said tongue cleaner integrally formed in conjunction with said handle portion.

19. The combination eating utensil and oral cleaning facility as defined in claim 18, further comprising a bristle brush located in said handle portion.

20. The combination eating utensil and oral cleaning facility as defined in claim 1, wherein said oral cleaning device is selected as said oral brush, located in said handle portion, selected from a group including a bristle brush and an abrasive scrubbing pad brush.

21. The combination eating utensil and oral cleaning facility as defined in claim 18 further comprising an additional oral cleaning device located in said handle portion between the tongue cleaner and said utensil portion, displaceably attached to adjacent handle material in at least one location configured with a score line enabling a user to displace and expose said additional oral cleaning device for use.

22. The combination eating utensil and oral cleaning facility as defined in claim 20 further comprising an additional oral cleaning device located in said handle portion between the bristle brush and said utensil portion, displaceably attached to adjacent handle material in at least one location configured with a score line enabling a user to displace and expose said additional oral cleaning device for use.
